(19) United States
(12) Patent Application Publication
(10) Pub. No.: US 2015/0199598 A1
(43) Pub. Date: Jul. 16, 2015

(54) Apparatus and Method for Grading Unstructured Documents Using Automated Field Recognition

(71) Applicant: Kenneth W. Iams, Santa Cruz, CA (US)

(72) Inventor: Kenneth W. Iams, Santa Cruz, CA (US)

(21) Appl. No.: 14/593,515

(22) Filed: Jan. 9, 2015

Related U.S. Application Data
(60) Provisional application No. 61/926,285, filed on Jan. 11, 2014.

(51) Int. Cl. G06K 17/00

(52) U.S. Cl. CPC G06K 17/0032

(57) ABSTRACT

A machine has a processor and a memory storing instructions executed by the processor to receive a semi-structured work product with question number indicia and answer indicia. Optical recognition techniques are employed to identify the question number indicia and answer indicia. Results are recorded in a database.

### CROSS-REFERENCE TO RELATED APPLICATION

This application claims priority to U.S. Provisional Patent Application Ser. No. 61/926,285, filed Jan. 11, 2014, the contents of which are incorporated herein by reference.

### FIELD OF THE INVENTION

This invention relates generally to computerized evaluation of documents. More particularly, this invention relates to techniques for grading unstructured documents using automated field recognition.

### BACKGROUND OF THE INVENTION

Technology has done little to improve the efficiency of grading student assignments. As a result, teachers are not using their limited time in the most productive manner to promote student achievement and students are not receiving timely feedback or incentivized to do their best work.

A typical student assignment involves students answering questions from their textbook either manually with paper and pencil or electronically with a digital file and an input device such as a stylus with touch display or keyboard. The amount of space required to answer each question as well as the location of the answer on the page will vary substantially from student to student. Subsequently for lengthy assignments the particular questions included on a page will also vary from student to student. Additionally, although students generally try to complete the questions of the assignment in the order in which they were assigned, some students work vertically in columns down the page while others work horizontally across the page. The unstructured nature of student work is further complicated by multi-page or multi-part assignments. This variability in student work makes assessment, which is already extremely time-consuming, even more difficult for the teacher.

The need remains for a means of automating the grading of student work that goes beyond multiple choice questions, isn't bound by preprinted worksheets, doesn't involve complicated initialization, and isn't susceptible to image registration difficulties associated with receiving inputs from multiple sources.

### SUMMARY OF THE INVENTION

A machine has a processor and a memory storing instructions executed by the processor to receive a semi-structured work product with question number indicia and answer indicia. Optical recognition techniques are employed to identify the question number indicia and answer indicia. Results are recorded in a database.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 displays a flowchart illustrating an embodiment of the invention for grading a typical student assignment.

FIG. 4 illustrates exemplary student homework completed on plain paper.

FIG. 5 illustrates exemplary student homework completed on lined binder paper.

FIG. 6 illustrates exemplary teacher modifications of an existing key.

FIG. 7 illustrates a database layout that may be used in accordance with an embodiment of the invention.

FIG. 8 illustrates an exemplary graded student homework image.

FIG. 9 illustrates sample alternative identifiers used in accordance with embodiments of the invention.

Like reference numerals refer to corresponding parts throughout the several views of the drawings.

### DETAILED DESCRIPTION OF THE INVENTION

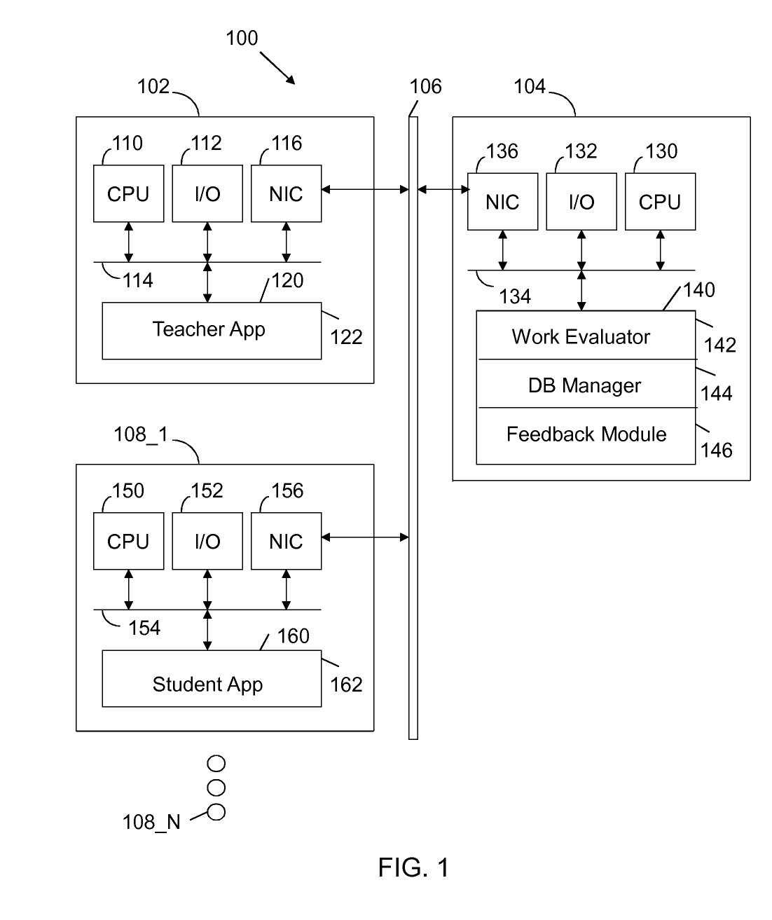

FIG. 1 illustrates a system 100 configured in accordance with an embodiment of the invention. The system 100 includes a machine 102 operated by an instructor or teacher, which is connected to a server 104 via a network 106. The network 106 may be any combination of wired and wireless networks. A set of machines 108_1 through 108_N are operated by students.

Machine 102 includes standard components, such as a central processing unit 110 connected to input/output devices 112 via a bus 114. The input/output devices 112 may include a keyboard, mouse, touch display and the like. A network interface circuit 116 is also connected to bus 114 to provide connectivity to network 106. A memory 120 is also connected to bus 114. The memory stores a teacher application 122. The teacher application includes instructions executed by processor 110 to coordinate teacher tasks, such as generating an assignment, updating assignment records and electronically communicating with students. The machine 102 may be a computer, tablet, mobile device, wearable device and the like.

Server 104 also includes standard components, such as a central processing unit 130, input/output devices 132, a bus 134 and a network interface circuit 136. A memory 140 is connected to the bus 134. The memory 140 includes instructions executed by the processor 130 to implement operations associated with embodiments of the invention. The memory 140 may store a work evaluator 142. The work evaluator 142 includes instructions to receive a semi-structured work product with question number indicia and answer indicia. A structured work product has pre-defined locations for work product and answers. A semi-structured work product does not have pre-defined locations for work product and answers. The only structure imposed is question number indicia and answer indicia, examples of which are provided below.

Optical character recognition techniques are used to identify the question number indicia and answer indicia. The question number indicia and answer indicia are compared to a key of question numbers and correct answers to produce student assignment results. The student assignment results are stored in database manager 144. A feedback module 146 coordinates communications with machine 102 and machines 108_1 through 108 N. The communications may relate to a graded work product with markups, suggestions about how to answer questions, assignment analytics, course analytics and the like.

Machines 108 also include standard components, such as a central processing unit 150, input/output devices 152, a bus 154 and a network interface circuit 156. A memory 160 is connected to the bus 154. The memory 160 stores a student application 162 which coordinates communications with server 104. For example, the student application 162 may include prompts for a student to take a photograph of a hand written assignment and may coordinate the delivery of the photograph to the server 104. The student application 162 may also be configured to display a graded assignment.

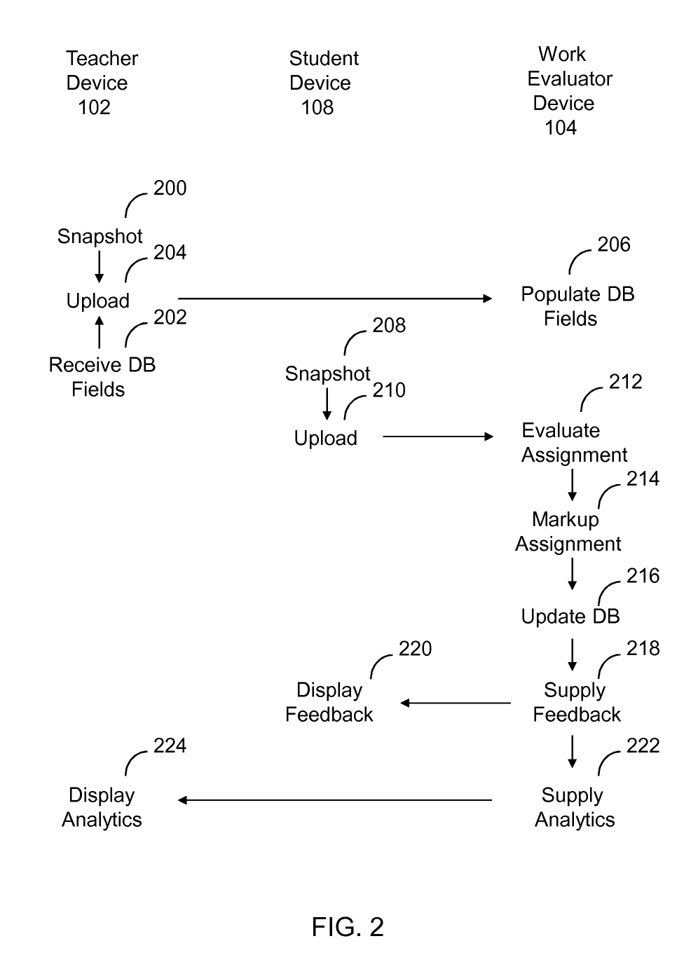

FIG. 2 illustrates processing operations associated with an embodiment of the invention. In particular, the figure illustrates operations performed by teacher device 102, student device 108 and server 104. The teacher device 102 may be used to take a snapshot 200 of a completed task. For example, the completed task may be a handwritten assignment with questions and answers. The resultant photograph is then uploaded 204 to server 104. The teacher device 102 may also be used to receive database fields 202, which are subsequently uploaded 204 to the server 104. The database fields 202 may be assignment parameters, such as student name, teacher name, class period and the like.

The server 104 populates database fields 206 from the materials uploaded from the teacher device 102. The database fields 206 may include question numbers, answers, student information, teacher information, class information and the like.

The assignment may be distributed to the students manually or electronically. The students perform their work either manually or electronically. In the case of manual work, upon completion, the student device 108 is used to take a snapshot 208 of the completed assignment, which is then uploaded 210 to server 104. Various examples of completed assignments are supplied below.

The work evaluator 142 of server 104 evaluates the assignment 212. The assignment may be marked up 214 with indicia of correct and incorrect answers. The markup may also include suggestions or hints about how to correctly answer a question. The database manager 144 is then updated 216. In particular, the database manager 144 is updated with a score for a student for a given assignment. The score may include information about individual questions answered correctly and incorrectly.

Feedback may then be supplied 218. The feedback may include a score, indicia of responses correctly or incorrectly answered, suggestions on how to answer incorrectly answered questions, and the like. The client device 108 displays the feedback 220. The feedback module 146 may be used to coordinate these operations. The feedback module 220 may also be configured to supply analytics 222, which may be displayed 224 on the teacher device 102. The analytics may include any number of measures of student performance.

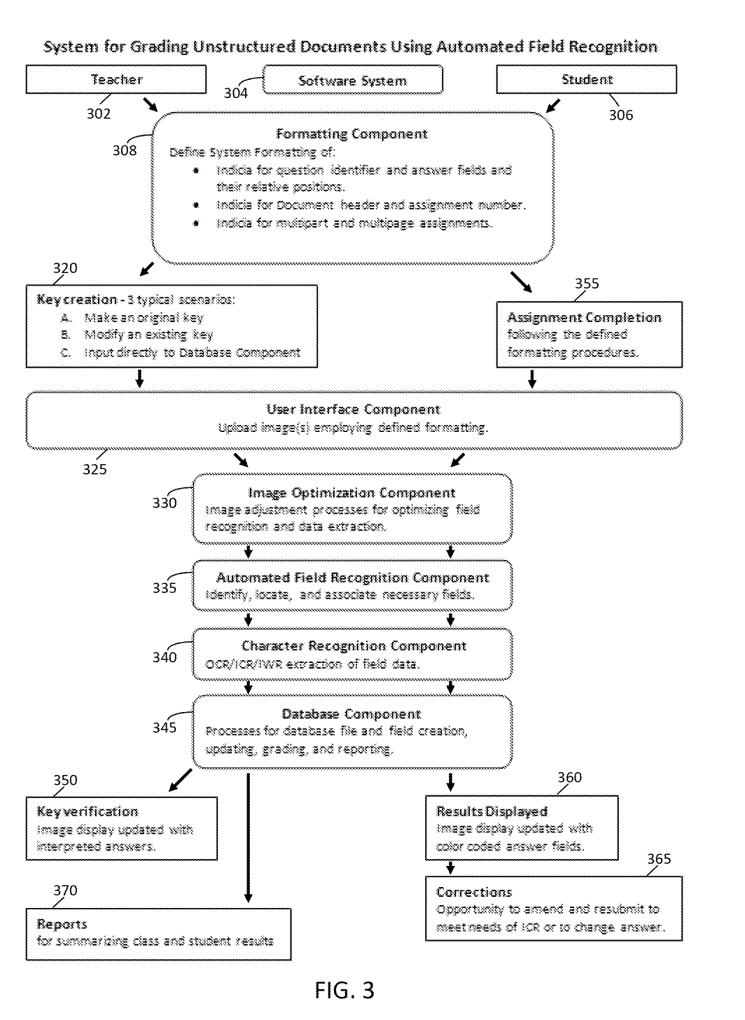

FIG. 3 shows an alternative view of how the components of FIG. 1 and processes of FIG. 2 define a system for grading a typical student assignment. The ability to automate the grading of a typical assignment despite the variability in student work caused either by the lack of predefined locations for work product and answers or image registration difficulties associated with receiving inputs (assignments) from multiple sources is accomplished by defining indicia that enable: computerized field recognition for auto generating specific database fields, locating boundaries of answer fields within individual documents, and association of each answer field with its corresponding question identifier. Although numerous options are available for defining the system formatting 308 it is desirable to select options that facilitate: auto field recognition and creation, OCR/ICR/IWR accuracy and efficiency, and proper implementation by teachers and students.

Indicia may include shapes (e.g., circle, rectangle, and bracket). Indicia may also include colors (pink and yellow for example) serving a secondary role in some answer key generation and digital ink scenarios described later. In one embodiment, a rectangle or bracket drawn by the author of the assignment is used to delineate answer fields 412 from other work on the page. A bracket can be used in place of a rectangle when an answer spans the entire width of the page as is often the case with sentences and paragraphs 510. For brackets the software system automatically defines an answer field as a rectangle extending rightward to the edge of the page from the highest and lowest points on the bracket, illustrated by the dotted lines 512. A circle 414 or 514 drawn by the author of the assignment to the direct left of each rectangle or bracket defines question identifier fields on the page.

Now that particular regions of the page have been defined with indicia as a certain type of database field entry, automatic database field generation is possible. Placing numbers and/or letters 416 inside the question identifier field circles 414 will automatically instruct the database to create an associated database field 706 when processing the key. During automated processing of teacher or student documents the conjoined question identifier field and question number directs the data 418 extracted from the associated answer field 412 to the appropriate cell of the auto generated database field for the teacher 716 or student 740.

As in the question and answer scenario, the proximity of indicia to one another can be used to associate fields as well as define individual fields. The use of proximity to differentiate fields aids accurate, efficient field recognition. Proximity may be significant if it is desirable to minimize the number of indicia utilized. For example, a triangle could be used as indicia for the assignment identifier field. However given that neat triangles are surprisingly hard to hand draw around characters, it is more convenient to use a circle or recognition equivalent oval shape. Even though a circle was utilized in the definition of a question identifier field it can still be used in the definition of an assignment identifier field. Proximity to other indicia as well as to page boarders will differentiate the two. Specifically to be considered a question identifier field a circle may be drawn to the direct left of a rectangle or bracket. To be considered an assignment identifier field, in one embodiment, the circle is not drawn to the direct left of a rectangle or bracket and is located in the top left corner of the page 402 or 502. Placing numbers and/or letters inside the assignment identifier field circles automatically instructs the database to create an associated database file 701 or part 703 for the teacher as well as direct teacher and student answers to the appropriate cells, for example part A 704 versus B 705 of Assignment 6 702, during processing. Additionally the characters within the circle can be used to differentiate which indicia it is. If all assignment numbers and no question numbers start with the letter “A” followed by numbers (representing the assignment number or date), any circles containing an “A” followed by numbers would be an assignment number field.

In one embodiment, a rectangle or bracket without a question identifier circle to its left is not recognized as an answer field and can be utilized for other applications. For example, a composite rectangular shape in the upper right of the paper 404 or 504 can be utilized to differentiate identifying header information. The large rectangular region can be subdivided into rectangle fields for student name 406 (top), student ID 408 (middle), teacher name or room number 410 (bottom left), and period number 412 (bottom right). Note the rectangular region can be formed utilizing the top and right edge of the page 404. This, along with the location of the assignment number field 402, helps ensure at least a portion of the page edges will be captured in the document image which is useful for optimizing alignment (discussed later).

Lastly with regard to defining the system formatting 308, indicators may be defined for differentiating multipart and multipage assignments to avoid cumbersome problem numbers that include reference to a particular part of the assignment. A means of differentiating parts of the assignment is often imperative because question numbers often revert back to starting numbers such as “1” 422 or repeat as the “5” does 424. Differentiation is accomplished by indicating a new part of the assignment with a line drawn substantially across the entire width of the page dividing it in two 426. This new part of the assignment requires a new assignment identifier field indicator placed in the upper left corner 420 and a differentiating assignment number 421. Question identifier fields are automatically associated with the assignment identifier field contained on the same page or part of the page. Recognizing a new part of the assignment on a teacher document the software system auto generates new database fields and cells 705 that are adjoined to the first part of the assignment 704 thus creating the complete assignment 702. Likewise if work continues from the front to the back of the page or to another page it is advisable to include the appropriate assignment number in the upper left corner. However, if missing, the software system can be configured to assume continuation of the last assignment number and header information identified.

Now that the system formatting considerations common to the teacher and students have been defined 308, the manner in which the teacher 302 and students 306 interact with the software system 304 and the role of the various software system components will be described in detail.

As seen in FIG. 3 the teacher determines an assignment and makes the key. The formation of the key 320 happens in one of three ways:

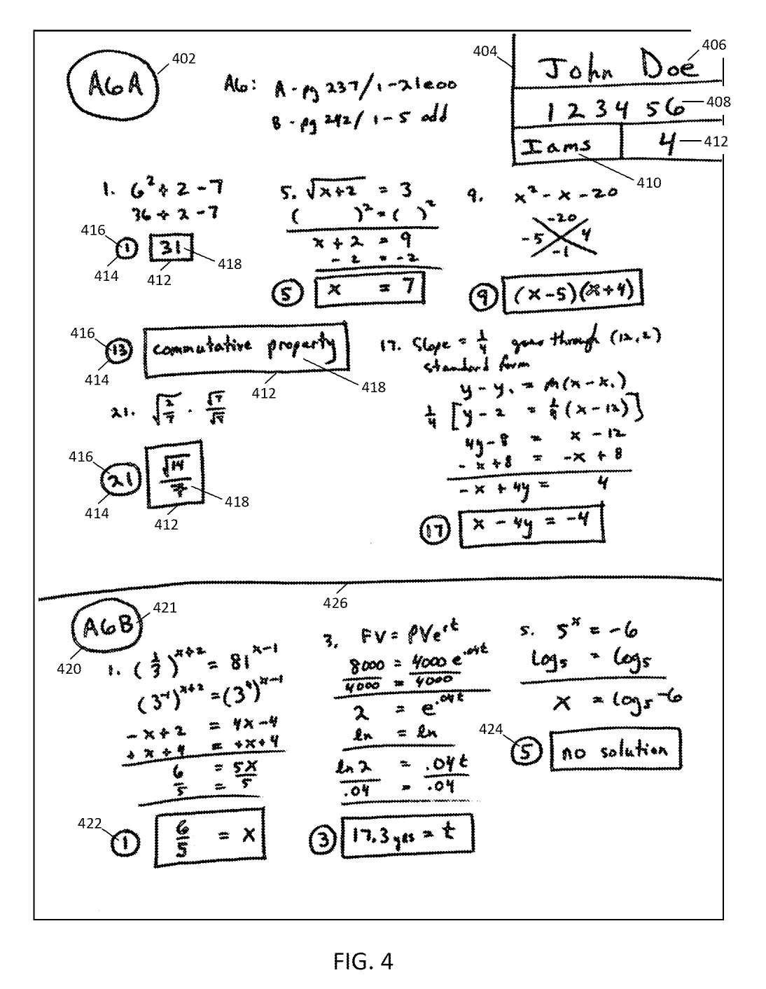

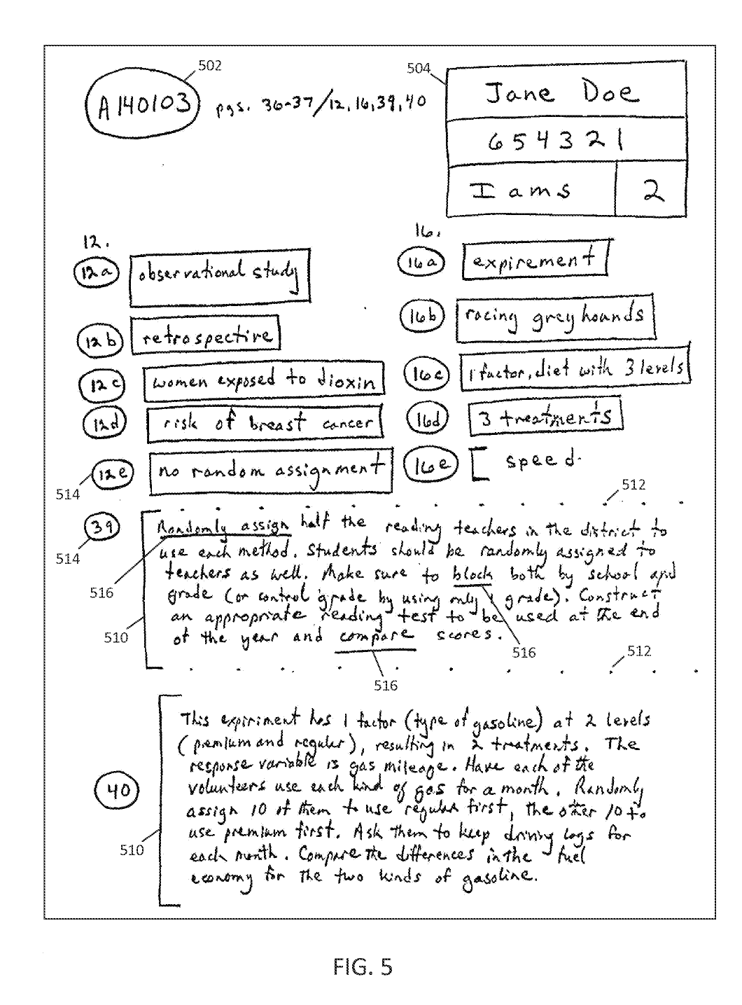

A. The teacher makes the key by creating, for example by handwriting or typing, solutions to the assigned questions utilizing the defined system formatting. The key may simply include question numbers and associated answers or it may look similar to the example student papers FIG. 4 or FIG. 5 if the teacher chooses to answer each question completely showing all required work.

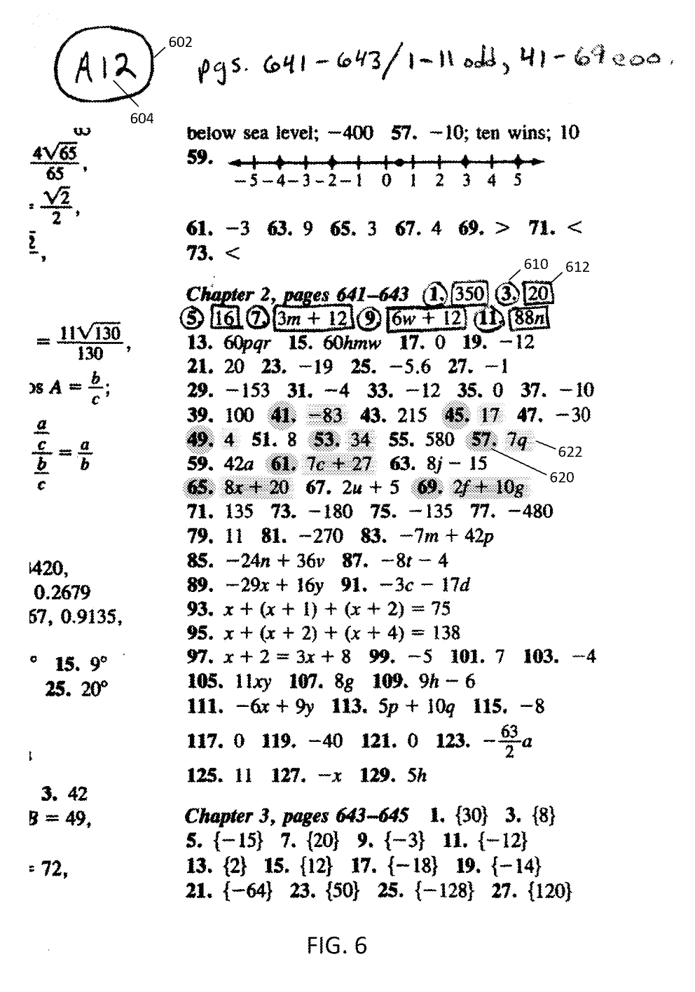

B. The teacher very quickly makes the key by selecting questions and answers from an existing key. For example, answers to questions are often provided in the back of the teachers editions of textbooks FIG. 6. If answers are provided according the defined system formatting, in this case to the right of question number, the teacher circles the question number to identify the region as a question identifier field 610 and boxes or brackets the associated answers to their right 612. This can be done on the original source material, a copy of the source material, or preferably a digital image of the source material as provided for by a component the software system (not depicted in FIG. 3). As seen in FIG. 6 the lack of space between answers or other formatting may make selecting with circles and rectangles difficult. In such situations alternative primary indicia, such as colors (pink and yellow for example) may be preferable. Highlighting in pink 620 defines question identifier fields in the same way as circles do and highlighting in yellow 622 delineates answer fields in the same way rectangles do. If utilizing a mouse or stylus the digital ink width can be set to an accommodating width. If the answers are not provided according to the defined system formatting the teacher may be able to alter the defined system formatting to accept the presented format or modify the information to achieve compliance, for example inserting question numbers.

C. The teacher makes the key by entering question numbers 706 and associated answers 716 directly into database fields associated with that particular assignment. This process can be expedited, for example with textbook assignments, by preloading the system with every question and answer. In such a scenario making the key is as simple as selecting for example Section 2.2, questions 1-21 odd.

Regardless of the methodology employed to make the key, additional grading cues may need to be indicated for more complicated answers. Examples include: underlining 516, boxing, circling, or highlighting within an answer field to select key words from sentences. Employing grading rules such as requiring at least some number of key words be included in a student answer to be considered correct, “either or” answers, required sequence, and graphs to name a few. Many basic requirements are selectable in or automated by the grading capabilities of the database component 345.

At step 325 the teacher having previously downloaded the required software app and created an account setting up their user information, class information, and preferences, can now create and upload a digital image of the key to the software system (options A or B above). Specifically with one click of an icon on their Smartphone, tablet, or computer with acceptable camera the app instructs the device to take and upload the required image(s) to the software system for processing. Alternatively various stages of image processing can be performed locally if desired.

Step 330 shows the image optimization component of the software system responsible for image adjustment processes. It is common for digital images from cameras and scanners to require initial adjustments to account for incorrect exposure, orientation, and deformations caused by camera lenses or paper alignment at image creation. Having paper edges and ruled lines found on most notebook paper for reference in the original image can aid alignment and adjusting for various deformations. On the other hand, ruled lines can potentially impede field recognition and data extraction necessitating additional processing. Additional processing is also employed as needed to optimize automated field recognition and character recognition. Reference back to characteristics and coordinates associated with optimal display states are maintained to facilitate displaying results to the teacher step 350 and students step 360.

Step 335 shows the component of the software system responsible for automated field recognition. Numerous image analysis techniques are available to recognize and locate the indicia and required associations of step 308, even if significant inconsistency exists due to them being hand drawn for example circles that look like ovals 502. A few of the many well -known computer image analysis options include: edge detection, threshold, Hough transform, contour vectorization, connected components, OpenCV, character recognition, bounding boxes, optical densities or colors, as well as numerous heuristics to distinguish indicia from each other as well as characters such as lowercase “o”, capital “O”, and zero or diagrams that may be present on the page. Size, area, proximity to page edges, proximity to other fields, roughly parallel sections, corner angles, contents, and colors are just a few means of differentiation. The image coordinates of all indicia on the page are classified, associated if necessary, and input to the database component of the software system to facilitate coordination with the character recognition component.

Step 340 shows the component of the software system responsible for OCR/ICR/IWR recognition and extraction. Utilizing image coordinates obtained from the Automated Field Recognition component of the software system, suitable OCR/ICR/IWR algorithms recognize machine print and/or unconstrained handwritten data from assignment identifier field(s), header fields, and the associated question identifier and answer field locations for input to the database component of the software system. Users are prompted when data in a field is unable to be recognized, for example having confidence values less than or equal to the threshold value.

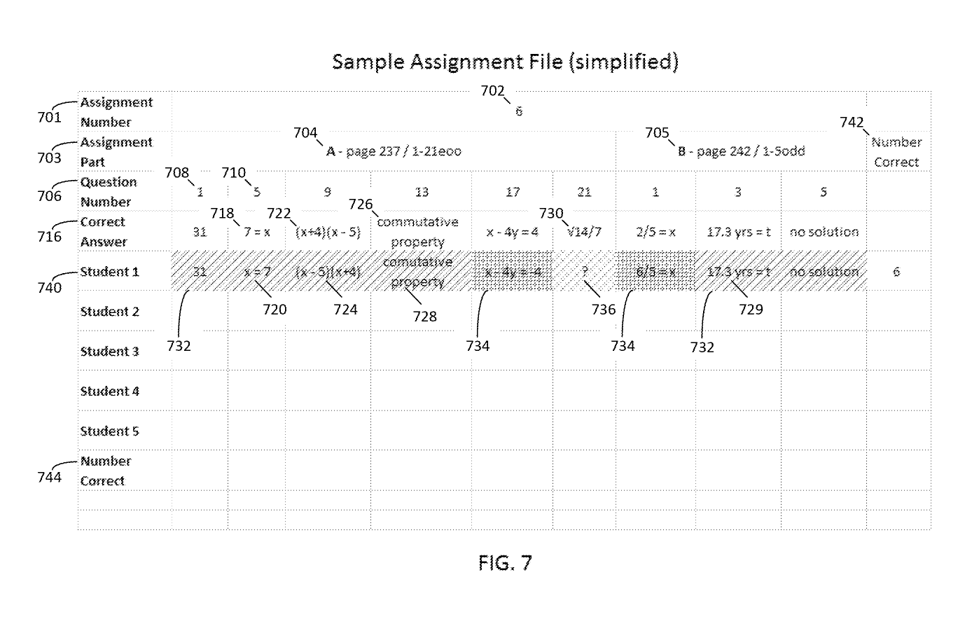

Step 345 shows the component of the software system responsible for database processes which works in conjunction with the component responsible for OCR/ICR/IWR extraction as well as other software system components. The database processes differ depending on whether data from a teacher's key or a student's assignment is being processed. When information provided by the recognition component of the software system comes from a teacher's key, the database utilizes the assignment number to determine if the information is for a new assignment 604, an additional part of an existing assignment 421, or simply a continuation of an existing assignment. If a new assignment number is detected a new database assignment file is created for the appropriate class. Fields are auto generated for each new question number recognized from the question identifier fields of the document image. Question numbers are input into the newly created database field cells 706 as are the associated correct answers 716 recognized from corresponding answer fields of the document image, the key for the student work. Because question identifier fields are automatically associated with the assignment identifier field contained on the same page, part 704 and multipart 705 assignments, such as shown in FIG. 4, are easily processed. To account for the potential for question numbers to be input out of order due to the layout of the key, the order in which field information was recognized, or the order in which pages were scanned, the database can automatically sort the entire assignment in ascending order 703, 706. This ensures an orderly presentation of information, organized by assignment number part if applicable, as seen in FIG. 7. For each assignment file cells are also created to receive information extracted from assignments submitted by students enrolled in the class 740 and accommodate calculations for grades 742 and reports 744.

Returning to FIG. 3, step 350 shows the component of the software system responsible for facilitating key verification. If the answer key was input by a digital image, as in scenarios A and B of step 320, the interpretation of the data extracted by the recognition component of the software system needs to be verified. For the teacher's key, the data being extracted from the answer fields often has limited contextual reference aside from any previously input into the database and character recognition algorithms. This decreases the accuracy of OCR and especially ICR/IWR. To improve the character recognition components ability to accurately interpret the teacher's handwritten marks, the teacher can submit an initial handwriting sample and the system can employ machine learning as the teacher interacts with the software system over time. Regardless, to facilitate efficient review of the interpreted answer fields, the digital image submitted by the teacher in step 325 or an adjusted image from step 330 is updated with the OCR/ICR/IWR interpreted data displayed in the associated answer field regions whose image coordinates were obtained and input to the database component in step 335.

From the teachers perspective they clicked an icon which took and displayed a picture of their key on their Smartphone, tablet, or computer then almost instantaneously replaced answer fields in the image with values interpreted by the software system. Interpreted values can be displayed in an alternate color font or offset if desired, the confidence value of the character recognition component for each field can be conveyed through intensity of a fill color shading of the answer field, and answer fields where interpretation was not possible can be filled with yellow. If interpretation errors are detected, the teacher can make revisions in a number of ways. For example they could resubmit a new, modified document image step 325, make changes by interacting with the answer field region on the adjusted image supplying or selecting corrections, or making changes to the database directly. The teacher may also have to access the database either directly or by interfacing with the answer field regions on the adjusted image to set grading interpretation preferences, create means for complex answers, or assign points to questions if not utilizing a defined point identifier field. Alternatively if the data for the key was input directly to the database component as in scenario C of step 320, the software system can provide for a digital display or facilitate printing of the ordered question numbers and associated answers if desired.

Now that the assignment file has been created and answers verified the software system is ready to process student work. Many components of the software system work substantially the same for students as they do for teachers. Therefore only important differences will be detailed in the following description of student interaction 306 with the software system.

At step 355 the student does the assignment handwriting and/or typing solutions to the assigned questions utilizing the defined system formatting of step 308. The assignment can be completed on any suitable writing surface such as traditional binder paper with pencil or pen FIG. 4. Alternatively if a tablet or suitable computer is available, the assignment can be completed in a digital file comprising information written with digital ink, typed, or entered through voice recognition software.

At step 325 the student, having previously downloaded the required software app and created an account setting up their user information, can now create and upload a digital image of their assignment, such as FIG. 4 or FIG. 5, to the software system. Specifically with one click of an icon on their Smartphone, tablet, or computer with acceptable camera the app instructs the device to take and upload the required image(s) to the software system for processing. Students without personal access to a compatible imaging device can utilize communal devices, provided in classrooms and the school library for example. Alternatively, assignments completed in a digital file are uploaded to the software system for processing without the need for a compatible imaging device.

Steps 330, 335, and 340 process student images in substantially the same manner described for teacher images. However due to individual answer field context provided by the teacher generated key as well as the availability of dynamic vocabularies, character recognition accuracy should improve. Nonetheless any students experiencing difficulty could provide initial handwriting samples if desired to aid recognition. Handwriting recognition has benefits to accompany the challenges. In particular, character recognition of handwritten assignments can ensure authenticity of a students work by comparing it with other submitted work. Likewise the location of indicia on each student image can work like a fingerprint to discourage multiple submissions.

Settings in the software app along with header and other field information, obtained in step 340, specifying teacher, period, assignment number, student name/number, and question number direct answer field data from the student's assignment also obtained in step 340 to the appropriate assignment field cells 740 of the database component 345. Examples of answer field data include numbers, expressions, equations, letters, words, phrases, sentences, graphs, and diagrams to name a few.

The grading capabilities of the database component determine if the student provided answers 740 are correct by comparing them with the correct answers 716 input by the teacher 302. Grading capabilities are also often shared by the character recognition component step 340 by utilizing context provided by the correct answer to improve recognition as compared to performing recognition independently then comparing the results. The grading process is also impacted by the operating point of the character recognition component that determines the right balance between read rate and error rate. While some answers are determined correct or not by simple comparison, others may require interpretation of equivalent answers, or more complex analysis. A few examples include: ignoring incidental marks, overlooking minor spelling mistakes 726,728, disregarding units 729, mathematically equivalent answers 718, 720, 722,724, acceptable synonyms, recognizing at least a certain number of key words from an answer comprised of sentences, requiring key words to appear in a particular order, determining equivalent graphs and diagrams, etc. In this assignment scenario the grading capabilities determine each student answer to be correct, incorrect, or unrecognized. The database is updated to reflect the grading determination and cells containing correct answers are, for example, shaded green 732, incorrect answers are shaded red 734, and unrecognized answers are shaded yellow 736. If desired the intensity of the fill color shading can be modified to convey the confidence value of the character recognition component.

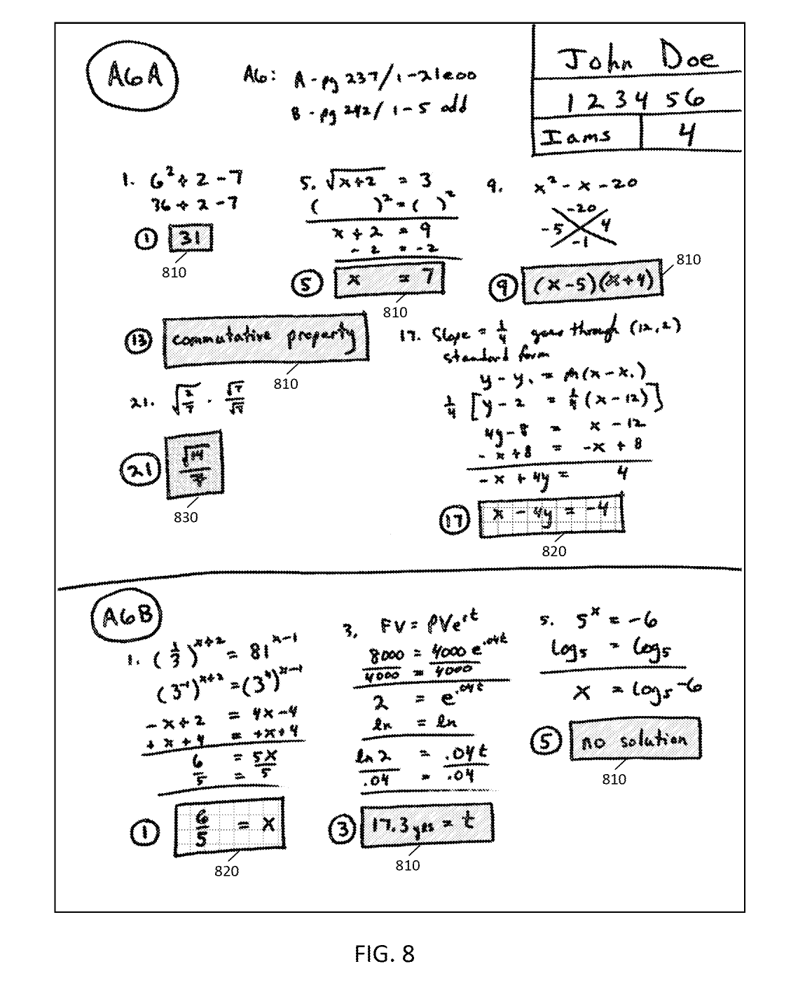

Step 360 shows the component of the software system responsible for displaying results to students. The digital image of the assignment FIG. 4 submitted by the student in step 325 or an adjusted image from step 330 is updated to reflect the determinations of the grading capabilities. Answer field regions whose image coordinates were obtained and input to the database component in step 335 are color coded to indicate correct (green 810), incorrect (red 820), and unrecognized (yellow 830) FIG. 8. Other unrecognized fields, such as assignment identifier and header fields, are also colored yellow to indicate a need for revision. From the students perspective they clicked an icon which took and displayed a picture of their assignment FIG. 4 on their Smartphone, tablet, or computer. Then almost instantaneously answer fields in the image were highlighted with green (correct), red (incorrect), or yellow (unrecognized) to indicate how they did, as shown in FIG. 8. Many other alternatives are possible including returning a total score, the correct answers, specific hints for problems missed, teacher praise, notification of omitted questions etc.

Having received feedback on their work, the student can be provided with opportunities to amend and resubmit their work, just as teachers were able to amend the key. Answers in yellow, unrecognized answer fields 830 can be modified to facilitate character recognition upon resubmission. This before and after data provides unique opportunities for character recognition machine learning. Answers in red, incorrect answer fields 820 can be updated with new answers to be evaluated upon resubmission. All resubmissions are tracked by the database component 345 where teachers can set associated scoring preferences.

With student work now processed and stored in the database component 345 a multitude of new reporting options are available to teachers and school officials. For example, in step 370 the software system can provide the teacher with a report detailing which questions were missed most often by the class 744 as well as information on individual student performance 742. Having received the report prior to class, the teacher can structure lesson plans to address identified student needs. If more detailed analysis of student work is desired the teacher can review individual student assignment images such as FIG. 8 now stored in the database component 345. Accessing individual student assignment images provides teachers, or tutors in remote locations, with opportunities to provide individualized written, audio, or video feedback on the entire assignment, including work done outside of answer fields. Scores can also be adjusted as necessitated by the increased scrutiny. Final scores can be copied and pasted into the teacher's preferred grading program if an interface with the software system is unavailable.

The above description contains many examples which should not be construed as limitations on the scope of the present invention, but rather as exemplifications of various embodiments thereof. Many other variations are possible.

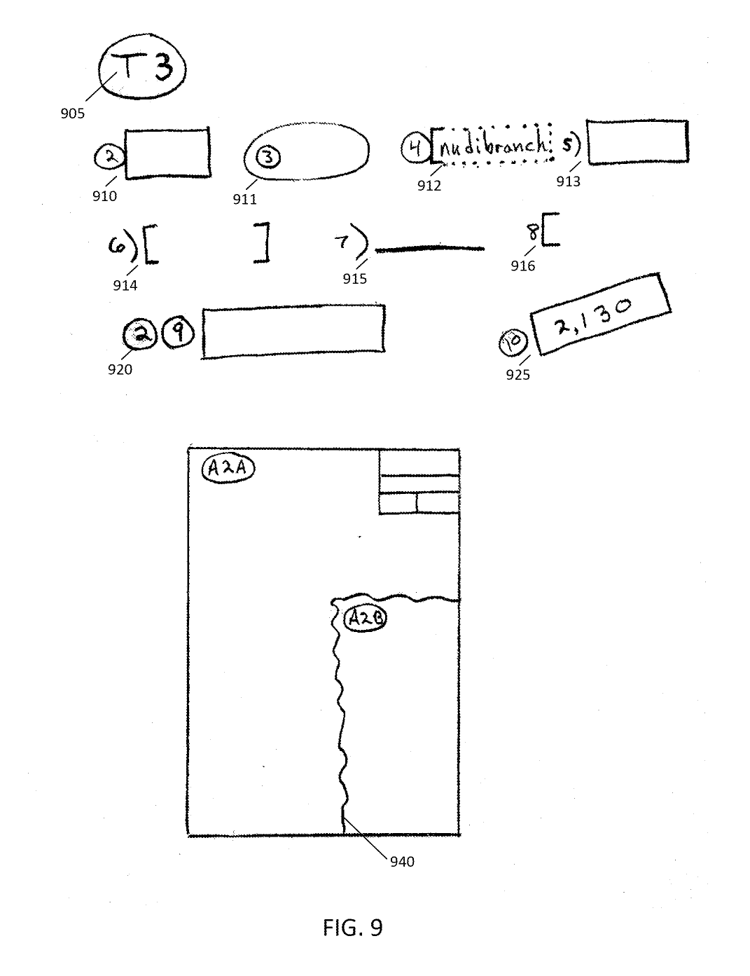

As previously mentioned it is desirable to select options for defining the system formatting 308 that facilitate: auto field recognition and creation, OCR/ICR/IWR accuracy and efficiency, and proper implementation by teachers and students. The options presented in the assignment scenario described can be modified in many ways to best serve a wide variety of applications or adapt to innovations in image analysis. FIG. 9 shows a few such modifications. It is important to note that some of these modifications are not suitable in various applications because they might be difficult to differentiate from other characters and markings on the document or increase recognition times. Item 912 shows how a bracket can be used to facilitate creation of a bounding box (dotted lines) defining an answer field around a string characters. Item 920 shows the addition of indicia for assigning points to questions, in this case a circle in front of the question identifier field. It is only utilized by the teacher to assign specific point values to a particular question in the database; question number 9 is identified as a 2 point question. Alternatively several shapes could be defined to represent question identifier fields worth predefined points. Item 925 shows how it may be advisable to perform character recognition oriented to each answer field rather than an overall page orientation. Likewise user drawn indicia can also be employed to aid overall page orientation and image optimization. For example in the absence of page edges or ruled lines in the original image, an overall horizontal could be determined by analyzing the lines used to define answer fields. Item 940 shows how squiggly line(s) can be used instead of straight lines to define the start of a new page if additional differentiation from other lines is desired. If a line can be drawn from a question identifier field to an assignment identifier field without crossing a page break, then they will be associated. Such strategies easily facilitate processing multi-part assignments that substantially separate the bottom right corner of the page from the rest of the page. Item 905 shows how changing the first letter in the assignment identifier field can be used to create a test assignment and associated database file rather than a homework assignment.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A machine, comprising:
a processor; and
a memory storing instructions executed by the processor to:
receive a semi-structured work product with question number indicia and answer indicia,
employ optical recognition techniques to identify the question number indicia and answer indicia, and
record results in a database.

2. The machine of claim 1 wherein the question number indicia includes a shape surrounding a number or letter.

3. The machine of claim 1 wherein the answer indicia includes a shape surrounding text, numbers, or other markings.

4. The machine of claim 1 wherein the answer indicia includes one or more symbols associated with text, numbers, or other markings.

5. The machine of claim 1 wherein the optical recognition techniques evaluate the relative position and proximity of the question number indicia and answer indicia.

6. The machine of claim 5 wherein the relative position and proximity of the question number indicia and answer indicia determine the function of particular indicia.

7. The machine of claim 5 wherein the relative position and proximity of the question number indicia and answer indicia are used to identify plagiarized work.

8. The machine of claim 1 wherein the memory stores instructions executed by the processor to:
receive a new semi-structured work product with question number indicia and answer indicia,
employ optical recognition techniques to identify the question number indicia and answer indicia, and
record new results in the database.

9. The machine of claim 1 wherein the optical recognition techniques are selected from optical character recognition, intelligent character recognition, intelligent word recognition, and image analysis.

10. The machine of claim 1 wherein the semi-structured work product includes assignment indicia.

11. The machine of claim 10 wherein the memory stores instructions executed by the processor to create a new database file corresponding to the assignment indicia and database fields corresponding to the question number indicia and answer indicia.

12. The machine of claim 1 wherein the semi-structured work product includes multiple page assignment indicia.

13. The machine of claim 1 wherein the memory stores instructions executed by the processor to receive an image of a key of question numbers and correct answers.

14. The machine of claim 13 wherein the image is an image of a teacher generated work product.

15. The machine of claim 13 wherein the image is an image of a pre-existing key of question numbers and correct answers.

16. The machine of claim 1 wherein the memory stores instructions executed by the processor to create database fields corresponding to question numbers and correct answers.

17. The machine of claim 1 wherein the memory storing instructions executed by the processor compare the question number indicia and answer indicia to a key of question numbers and correct answers to produce student assignment results and record the student assignment results in a database.

18. The machine of claim 17 wherein the instructions executed by the processor include instructions to supply a markup of the semi-structured work product.
